(19) United States
(12) Patent Application Publication
(10) Pub. No.: US 2026/0139131 A1
(43) Pub. Date: May 21, 2026

(54) Modified Polyethylene and Articles Made Therefrom

(71) Applicant: ExxonMobil Technology and Engineering Company, Spring, TX (US)

(72) Inventors: Wen Li, Houston, TX (US); Adriana S. Silva, Houston, TX (US); Jianya Cheng, Kingwood, TX (US); David B. Dunaway, The Woodlands, TX (US); Periagaram S. Ravishankar, Kingwood, TX (US); Ching-Tai Lue, Sugar Land, TX (US); Francis C. Rix, Winston Salem, NC (US); Peijun Jiang, Katy, TX (US)

(21) Appl. No.: 19/145,091

(22) PCT Filed: Jan. 19, 2024
(86) PCT No.: PCT/US2024/012264

§ 371 Date: Jul. 1, 2025

Related U.S. Application Data
(60) Provisional application No. 63/482,883, filed on Feb. 2, 2023.

(51) Int. Cl. C08L 23/0807; C08J 5/18

(52) U.S. Cl. CPC C08L 23/0815; C08J 5/18; C08J 2323/08; C08J 2423/16; C08L 2203/16; C08L 2205/025; C08L 2207/066; C08L 2314/06

(57) ABSTRACT

The present disclosure provides modified polyethylenes, articles, such as films, made therefrom, and methods of forming the compositions and films. Films from blends of certain polyethylenes and certain modifiers exhibit a new and useful balance of properties. Maximum output of film production equipment can be increased while maintaining or improving other film properties such as stiffness, tear resistance, tensile strength, and scaling performance of a polyethylene with the addition of the modifier. Surprisingly, optical properties, such as haze, of polyethylene film are dramatically improved through the addition of modifier.

### CROSS-REFERENCE TO RELATED APPLICATION

This application claims the benefit of U.S. Provisional Application 63/482,883, filed Feb. 2, 2023, entitled “MODIFIED POLYETHYLENE AND ARTICLES MADE THEREFROM”, the entirety of which is incorporated by reference herein.

### FIELD OF THE INVENTION

The present disclosure provides modified polyethylenes, articles, such as films, made therefrom, and methods of forming the compositions and films.

### BACKGROUND OF THE INVENTION

Polyethylene and compositions containing polyethylene are useful in many applications, such as in films. The blown film technique, for example, is a useful way to manufacture polyethylene films. One use of such films is in making bags, where the films can be formed as continuous cylinders then crimped to close one end. The process to blow polyethylenes into such films, however, involves a balance between processability (e.g., flowability and melt strength) of the polymer on the one hand and mechanical properties (e.g., tensile strength, modulus) of the polymer on the other. Improving processability while maintaining mechanical properties could facilities increased production rates and more economic production of films and bags.

Polyethylene polymers are typically made from ethylene and a C₃-C₆-olefin comonomer with a variety of catalyst systems using Ziegler-Natta catalysts, chrome catalysts, metallocene catalysts, etc., in a variety of processes including gas-phase processes, solution processes, high pressure tubular processes, slurry processes, and sometimes combinations of these processes.

In general, metallocene catalyzed polyethylenes (mPE) can be more difficult to process than low-density polyethylenes (LDPE) made in a high-pressure polymerization process. For example, mPEs (which tend to have narrow molecular weight distributions and low levels of branching) require more motor power and produce higher extruder pressures to match the extrusion rate of LDPEs. Typical mPEs also have lower melt strength which, for example, reduces bubble stability during blown film extrusion and reduces melt fracture stability at commercial shear rates. On the other hand, mPEs exhibit supenor physical properties for some uses as compared to LDPEs. Various levels of LDPE can be blended with the mPE to increase melt strength, to increase shear sensitivity, e.g. to increase flow at commercial shear rates in extruders; and to reduce melt fracture. However, these blends generally have poor mechanical properties as compared with neat mPE.

Regarding bubble stability, high melt strength is desirable for blown film processability as it provides bubble stability. In polyethylene, molecular weight, molecular weight distribution and long chain branching are influential to melt strength. Lowering the melt index and broadening molecular weight distribution on the high molecular weight side can effectively achieve high melt strength but inevitably increase melt viscosity and thus reduce extrudability. Enhancing melt strength through long chain branching (LCB), by either incorporating LCB directly in a polyethylene backbone or blending LDPE into a base resin, has a negative impact on a film's mechanical properties. It would be advantageous to be able to control the melt strength of a polymer composition without interfering with the melt extrusion and physical properties.

For many polyolefin applications, including films and fibers, increased melt strength is a desirable attribute. Higher melt strength allows fabricators to run their blown film lines at a faster rate. It also allows them to handle thicker films in applications such as geomembranes.

References of potential interest in this regard include: US 2007/0260016; U.S. Pat. Nos. 5,670,595; 6,903,162; 6,509,431; 10,808,049; 10,125,247; US 2020/0223951; and US 2018/0265657.

There is a need for modified polyethylenes and films having, for example, high melt strength and maintained or improved melt extrudability and other physical properties. There is further a need for methods of forming modified polyethylenes and films having, for example, high melt strength and maintained or improved melt extrudability and other physical properties.

### SUMMARY OF THE INVENTION

In one aspect, embodiments of the invention provide modified polyethylene compositions comprising the product of the combination of (1) 90-99.9 wt. % of a polyethylene comprising 85-99.9 wt % of units derived from ethylene and units derived from a C₃ to C₁₀ alpha-olefins, the polyethylene having a density of 0.900 to 0.940 g/cm³; and (2) from 0.10-10 wt % of an ethylene copolymer elastomeric modifier, the modifier comprising at least 70 wt % of units derived from ethylene and from 0.01-20 wt % of units derived from a C₃ to C₁₀ alpha-olefin. In some embodiments, the modifier may further comprise 0.01-10 wt % of units derived from a cyclic-diene monomer, such that the modifier is a cyclic-diene ethylene terpolymer. Whether a copolymer or, more specifically, a terpolymer, the modifier is preferably highly branched.

Other embodiments of the invention provide for improved films formed from such modified polyethylene compositions and improved processes for producing films from such modified polyethylenes.

The present inventors have discovered that films from blends of certain polyethylenes and certain modifiers exhibit a new and useful balance of properties. Additionally, maximum output of film production equipment can be increased by as much as 15 percent or more while maintaining or improving other film properties such as stiffness, tear resistance, tensile strength, and sealing performance of a polyethylene with the addition of modifier to a polyethylene as 10 percent or less of the total composition. Surprisingly, optical properties, such as haze, of polyethylene film are dramatically improved through the addition of modifier as 10 percent or less of the total composition.

### DETAILED DESCRIPTION

The present disclosure provides modified polyethylene compositions, films comprising such compositions, and methods for making films comprising such compositions. Films from modified polyethylenes of the present disclosure and/or formed by methods of the present disclosure exhibit a new and useful combination of properties. High melt strength is achieved while maintaining or improving melt viscosity (that is, shear thinning in processing of the modified polyethylene); all while incurring minimal, if any, impact on film physical properties. Stiffness, tear resistance, tensile strength, and sealing performance are generally maintained or enhanced with the addition of modifier to a polyethylene as 10 percent or less of the total composition. Although dart impact performance is reduced somewhat with addition of the modifier to polyethylene, this may be far outweighed by the previously mentioned film attributes providing equal or improved performance at increased throughput rates. Additionally, optical properties, such as haze, of polyethylene are dramatically improved through the addition of modifier as 10 wt % or less of the total modified polyethylene composition, preferably 5 wt % or less (on basis of mass of the modified polyethylene composition).

These attributes provide bubble stability improvement as compared to conventional compositions and methods and pros ide a substantial increase in output of film. Increased melt strength (e.g., extensional strain hardening) allows a bubble to balance its own weight before solidifying, thus contributing to improved bubble stability, film gauge uniformity, and an ability to blow large bubbles (e.g., geomembranes).

### Definitions

For purposes of the present disclosure, the numbering scheme for the Periodic Table Groups is according to the new notation of the IUPAC Periodic Table of Elements.

As used herein. “olefin polymerization catalyst(s)” refers to any catalyst, typically an organometallic complex or compound that is capable of coordination polymerization addition where successive monomers are added in a monomer chain at the organometallic active center.

The terms “substituent,” “radical,” “group,” and “moiety” may be used interchangeably.

As used herein, and unless otherwise specified, the term “Cₙ” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

A “polymer” has two or more of the same or different monomer (“mer”) units. A “homopolymer” is a polymer having mer units that are the same. A “copolymer” is a polymer having two or more mer units that are distinct or different from each other. A “terpolymer” is a polymer having three mer units that are distinct or different from each other. “Distinct” or “different” as used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer comprising at least 50 wt % ethylene derived units, a “propylene polymer” or “propylene copolymer” is a polymer or copolymer comprising at least 50 wt % propylene derived units, and so on.

“Polymerizable conditions” refer to those conditions including a skilled artisan's selection of temperature, pressure, reactant concentrations, optional solvent/diluents, reactant mixing/addition parameters, and other conditions within at least one polymerization reactor that are conducive to the reaction of one or more olefin monomers when contacted with an activated olefin polymerization catalyst to produce the desired polyolefin polymer through typically coordination polymerization.

The term “continuous” means a system that operates without interruption or cessation. For example, a continuous process to produce a polymer would be one where the reactants are continually introduced into one or more reactors and polymer product is continually withdrawn.

A “catalyst composition” or “catalyst system” is the combination of at least two catalyst compounds, a support material, an optional activator, and an optional co-activator. For the purposes of this invention and the claims thereto, when catalyst systems or compositions are described as comprising neutral stable forms of the components, it is well understood by one of ordinary skill in the art, that the ionic form of the component is the form that reacts with the monomers to produce polymers. When it is used to describe such after activation, it means the support, the activated complex, and the activator or other charge-balancing moiety. The transition metal compound may be neutral as in a precatalyst, or a charged species with a counter ion as in an activated catalyst system.

Coordination polymerization is an addition polymerization in which successive monomers are added to or at an organometallic active center to create and/or grow a polymer chain.

The terms “cocatalyst” and “activator” are used herein interchangeably and are defined to be any compound which can activate any one of the catalyst compounds herein by converting the neutral catalyst compound to a catalytically active catalyst compound cation.

The term “contact product” or “the product of the combination of” is used herein to describe compositions wherein the components are contacted together in any order, in any manner, and for any length of time. For example, the components can be contacted by blending or mixing. Further, contacting of any component can occur in the presence or absence of any other suitable component of the compositions described herein. Combining additional materials or components can be done by any suitable method. Further, the term “contact product” includes mixtures, blends, solutions, slurries, reaction products, and the like, or combinations thereof. Although “contact product” can include reaction products, it is not required for the respective components to react with one another or react in the manner as theorized. Similarly, the term “contacting” is used herein to refer to materials which may be blended, mixed, slurried, dissolved, reacted, treated, or otherwise contacted in some other manner.

A “composition” of the present disclosure can include the components of the composition, contact products of the composition and/or reaction product(s) of the components of the composition. A film of the present disclosure can comprise a composition.

A “copolymer” as used herein refers to a polymer derived from polymerization of two or more comonomer units, and may for instance include terpolymers (i.e., polymers formed from polymerization of three comonomer units).

### Polyethylenes

In general, the polyethylene component of the modified polyethylene composition comprises 85-99.9 wt,% of units derived from ethylene with the remaining balance being units derived from C₃ to C₂₀, preferably C₃ to C₁₀, alpha-olefins such as 1-butene, 1-hexene, and/or 1-octene (said wt % s based on total molecular weight of the polyethylene component). The polyethylene component in various embodiments may comprise ethylene-derived units from a low end of any one of 85, 86, 87, 89, or 91 wt % to a high end of 95, 96, 97, 98, 98.5, 99, or 99.5 wt %; with ranges from any foregoing low to any foregoing high contemplated. The balance in each instance is comprised of the α-olefin comonomer(s).

Density of the polyethylene component may be within the range from 0.900 to 0.950 g/cm³, such as from a low of any one of 0.905, 0.910, 0.911, or 0.912 g/cm³ to a high end of any one of 0.915, 0.920, 0.925, 0.930, 0.935, 0.940, 0.945, or 0.950 g/cm³, with ranges from any foregoing low to any foregoing high contemplated (e.g., 0.905 to 0.935 g/cm³, or 0.910 to 0.950 g/cm³).

The polyethylene can have melt index (MI, also referred to as I₂ or I_{2.16} in recognition of the 2.16 kg loading used in the test) within the range from 0.1 to 10 g/10 min (ASTM D1238, 190° C., 2.16 kg load), preferably 0.1 to 5.0 g/10 min, such as within the range from any one of 0.1, 0.5, 0.7, or 1.0 to a high of any one of 1.0, 1.3, 1.5, 2.0, 2.5, 3.0, 3.5, 4.0, 4.5, 5.0, 5.5, 6.0, 6.5, 7.5, or 10 g/10 min. with ranges from any foregoing low end to any foregoing high end contemplated (provided the high is greater than the low).

The polyethylene may furthermore have weight-average molecular weight (M_{w}) within the range from 50,000 to 300.000 g/mol, such as from a low of any one of 50.000; 60,000; or 70,000 g/mol to a high of any one of 110,000; 115,000; 125,000; 130,000; 140,000; 150,000; 160,000; 165,000; 170,000; 200,000; 250,000; or 300,000 g/mol, with ranges from any foregoing low end to any foregoing high end also contemplated herein (e.g., 50,000 to 120,000 g/mol in some embodiments, or 70,000 to 160,000 g/mol, such as 70,000 to 130,000 g/mol).

Specific examples of suitable polyethylene include various particular types of LLDPE (linear low density polyethylene), and in particular various types of metallocene-catalyzed LLDPE (mLLDPE), such as: (i) narrow composition distribution mLLDPE (referred to herein as narrow-CD mLLDPE); (ii) long-chain branched mLLDPE (LCB mLLDPE); (iii) mLLDPE having a combination of narrow molecular weight distribution and broad orthogonal composition distribution (referred to as Narrow-MWD BOCD-mLLDPEs); and (iv) mLLDPE having a combination of broad MWD and BOCD (referred to herein as Broad-BOCD-mLLDPE). Each particular example is discussed in turn, below.

Narrow-CD mLLDPE

A narrow-CD mLLDPE can, for instance, comprise a flat composition distribution metallocene-catalyzed LLDPE (mLLDPE) that is a copolymer of 80 to 99.9 wt % ethylene-derived units, with the balance of units derived from one or more C₃ to C₁₂ α-olefin comonomer (and in particular one or more of butene, hexene, octene; preferably one of those, and more preferably hexene). The wt % is based on total mass of ethylene-derived units plus comonomer-derived units in the polyethylene. Such polyethylenes are referred to as “flat composition distribution” in recognition that comonomer is incorporated in relatively equal amounts (by wt %) in shorter vs. longer molecular-weight chains within the polymer. These also may be referred to as “narrow-CD” or “narrow-composition-distribution” polyethylenes; or, equivalently, high-CDBI mLLDPEs. Composition distribution refers to the distribution of comonomer among polymer chains of different length (different molecular weight), and CDBI refers to Composition Distribution Breadth Index, which is defined as the weight percent of the copolymer molecules (chains) having a comonomer content within 50% of the median total molar comonomer content, and it is described in U.S. Pat. No. 5,382,630, which is hereby incorporated by reference. The CDBI of a copolymer is readily determined utilizing well known techniques for isolating individual fractions of a sample of the copolymer. One such technique is Temperature Rising Elution Fractionation (TREF), as described in Wild, et al., J. Poly. Sci., Poly. Phys. Ed., vol. 20, p. 441 (1982) and U.S. Pat. No. 5,008,204, which are incorporated herein by reference. Thus, a higher value of CDBI indicates a narrow composition distribution (meaning that comonomer is distributed relatively evenly across polymer chains of different molecular weight).

The narrow-CD polyethylene can be made using an unbridged bis-cyclopentadienyl Group 4 and substituted versions thereof.

The narrow-CD polyethylene can have CDBI of at least 50%, more preferably at least 60%, such as within the range from 50 to 90%, or 60 to 80%.

A narrow-CD polyethylene may more particularly have ethylene-derived content within the range from a low of any one of 80, 85, 86, 87, 87.5, 88, 90, 91, 92, 93, 94 or 95 wt % to a high of any one of 88, 90, 93, 94, 95, 96, 97, 98, 99, or 99.9 wt %; with ranges from any foregoing low to any foregoing high contemplated, provided the high end is greater than the low end (e.g., 85 to 95 wt %, such as 86 to 92 wt % ethylene-derived units; or 94 to 99 wt % ethylene-derived units). The balance is comprised of the C₃ to C₁₂ α-olefin comonomer-derived units (e.g., hexene).

The narrow-CD mLLDPE preferably also has one or more, preferably all, of the following further properties:
Vicat softening temperature (ASTM D1525) within the range from softening point within the range from 70° C. to 130° C., preferably 90° C. to 110° C., such as from a low of any one of 70, 75, 80, 85, 90, 95, 96, 97, 98, 99, or 100° C. to a high of any one of 100, 101, 102, 103, 104, 105, 110, 115, 120, 125, or 130° C. (with ranges from any foregoing low to any foregoing high contemplated, provided the high is greater than the low, e.g., 90° C. to 110° C. or 97° C. to 103° C.).
Melt index (MI, also referred to as I₂ or I_{2.16} in recognition of the 2.16 kg loading used in the test) within the range from 0.1 to 5.0 g/10 min (ASTM D1238, 190° C., 2.16 kg load), such as from a low of any one of 0.1, 0.2, 0.3, 0.4, 0.5, 0.7, or 0.8 g/10 min to a high of any one of 1.0, 1, 1, 1.2, 1.5, 2.0, 2.5, 3.0, 3.5, 4.0, 4.5, or 5.0 g/10 min; with ranges from any foregoing low end to any foregoing high end also contemplated.
Long chain branching index (LCB Index, also referred to herein as g′ᵥᵢₛ or g′ index) greater than 0.95, preferably greater than or equal to 0.96 or 0.97.

The narrow-CD mLLDPE can also have one or more, preferably all of the following:
Weight average molecular weight (M_{w}) within the range from 45,000 to 120,000 g/mol, such as from 50,000 to 115,000 g/mol or 60,000 to 110,000 g/mol (with ranges from any foregoing low end to any foregoing high end also contemplated, e.g., 45,000 to 110,000 g/mol);
Number average molecular weight (Mₙ) within the range from 20,000 to 55,000 g/mol, such as within the range from 25,000; 30,000; 35,000; or 40,000 to a high of 30,000; 35,000; 40,000; 45,000; 50,000; or 55,000 g/mol, with ranges from any foregoing low end to any foregoing high end also contemplated (provided the high end is greater than the low end), e.g., from 35,000 to 55,000 g/mol;
Molecular weight distribution (MWD, defined as Mw/Mn) within the range from 1.5 or 2.0 to 3.5 or 4; and
Density (ASTM D1505) within the range from 0.905 to 0.940 g/cm³, such as within the range from a low end of any one of 0.905, 0.910, 0.911, 0.912, or 0.915 g/cm³ to a high end of any one of 0.913, 0.914, 0.915, 0.920, 0.925, 0.926, 0.928, 0.930, 0.935, or 0.940 g/cm³, with ranges from any foregoing low end to any foregoing high end contemplated (provided the high end is greater than the low end), e.g., 0.910 to 0.915 g/cm³.

### LCB-mLLDPE

In some embodiments, the mLLDPE can be made using a metallocene catalyst that is a bridged bis-cyclopentadienyl Group 4 and substituted versions thereof, as disclosed in one or more of U.S. Pat. Nos. 6,255,426 and 6,476,171, the contents of which are fully incorporated by reference herein. Such catalysts produce polyethylene grades having some long-chain branching (as compared to the highly linear structure of most mLLDPEs), and are referred to herein as “LCB-mLLDPE.”

Long chain branched mLLDPEs (“LCB mLLDPE”) are considered long-chain-branched as compared to other linear low-density polyethylenes, and in particular as compared to other metallocene LLDPEs; whereas their total long-chain branching will still be less than LDPEs with very high degrees of long-chain branching.) This small amount of LCB can be evidenced through, e.g., a high melt index ratio (MIR) and/or particular rheology characteristics as shown through data obtained by small angle oscillatory shear (SAOS) experiments (for instance, ratio of η_{0.01}/η₁₀₀, the complex viscosity recorded at shear rates of 0.01 and 100 rad/s, respectively). Another useful parameter for indicating the presence of LCB is a Van Gurp Palmen (VGP) plot, an example of which can be seen in FIG. 3 of US 2022/0259417, which is incorporated by reference herein. In particular, polyethylene copolymers (even LLDPE) with some LCB will exhibit an inflection point in their VGP curve, while LLDPE without any LCB present show no such inflection point. See, for example, the Enable™ brand LLDPEs, examples of LCB-mLLDPEs, in FIG. 3 of US 2022/0259417, as compared to the XP8318 of FIG. 3 of the '417 publication, which is an example of the narrow-MWD BOCD-mLLDPEs discussed below.

Yet another useful parameter illustrating presence of some LCB can be seen in the melt index ratio. Melt index ratio (MIR) is the ratio of high load melt index (HLMI, ASTM D1238 at 190° C. 21.6 kg) to melt index (MI₂, ASTM D1238 at 190° C., 2.16 kg).

Accordingly, LCB-mLLDPEs useful for the present compositions can have one or more of the following properties (which can be useful indicia of moderate LCB):
MIR within the range from a low of any one of 20, 25, 26, 27, 28, 29, 30, or 31 to a high of any one of 40, 35, 34, 33, 32, 31, or 30 with ranges from any of the foregoing lows to any of the foregoing highs contemplated herein (e.g., 27 to 33, such as 28 to 32, or 29 to 31).
Complex shear viscosity (η*)@0.01 rad/sec and 190° C. in the range of 5,000 to 12,000 Pa·s; or from a low of any one of 5,000; 6,000; 7,000; 8,000; 9,0000; 10,000; or 11,000 Pa·s, to a high of any one of 12,000; 11,000; 10,000; 9,000; 8,000; 7,000; or 6.000 Pa·s, with ranges from any low end to any high end contemplated (e.g., 6,000 to 8,000 Pa·s).
Complex shear viscosity (η*) @100 rad/sec and 190° C. within the range from 900 to 2000 Pa·s; such as from a low end of any one of 900; 1,000; 1,100; or 1,200 Pa·s to a high end of any one of 1,200; 1,300; 1,400; 1,500; or 2,000 Pa·s, with ranges from any foregoing low to any foregoing high also contemplated (e.g., 1,100 to 1,300 Pa·s).
Shear thinning ratio (η*@0.01/100) less than 15, or in the range of 3 to 15, or 4 to 12, or 5 to 10, or 5.5 to 8.
An inflection point in a Van Gurp Palmen plot of phase angle vs. complex modulus (Pa) of the LCB-mLLDPE.

Finally, yet another indicator of LCB can be seen in the LCB index (g′ or alternatively g′vis), which for LCB-mLLDPE could be less than 1, such as within the range from 0.9 to 0.99 or 0.94 to 0.98, although still substantially higher than g′ for heavily-LCB polyethylene, such as LDPE made using free radical polymerization.

Suitable mLLDPEs with the aforementioned moderate LCB are preferably copolymers of 80, 85, 88, 90, 92, 93, 94, or 95 to 6, 97, 98, or 99 wt % ethylene-derived units, with the balance derived from one or more C₃ to C₁₂ α-olefins (and in particular one or more of butene, hexene, octene; preferably one of those; and more preferably hexene). The wt % is based on total mass of ethylene-derived units plus comonomer-derived units in the polyethylene.

Suitable LCB mLLDPEs can also have a CDBI greater than or equal to 60%, preferably greater than or equal to 70%, such as within the range from a low of any one of 60, 70, or 75% to a high of 80, 85, 90, 95, or 99%, with ranges from any foregoing low end to any foregoing high end contemplated. Composition Distribution Breadth Index (“CDBI”) is defined as the weight percent of the copolymer molecules having a comonomer content within +/−50% of the median comonomer mol % value, as described at pp. 18-19 of WO 1993/003093 in conjunction with FIG. 17 therein. This means that for a copolymer having median comonomer mol % value (Cmed) of 8 mol % comonomer on a polymer chain. CDBI is the wt % of copolymer chains having comonomer mol % that is between (0.5×Cmed) and (1.5×Cmed). In this example, CDBI is the wt % of copolymer chains having comonomer mol % between (0.5×8) and (1.5×8), or comonomer content between 4 mol % and 12 mol %. WO 1993/003093 also describes the process for determining the weight fraction of polymer vs. composition curve (i.e., the composition distribution curve) using chromatography and C13 NMR, and determining the median comonomer composition Cmed therefrom, with reference to FIGS. 16 and 17 of that publication. See also Wild, et al., J. Poly. Sci., Poly. Phys. Ed., vol. 20, p. 441 (1982) and U.S. Pat. No. 5,008,204, which are also incorporated herein by reference.

Suitable LCB mLLDPEs can also have a MWD (Mw/Mn) within the range of 2.5 to 5.5, such as within the range of 3 or 3.5 to 4.5 or 5.

Suitable LCB mLLDPEs can further have a Melt Index (I₂, determined per ASTM D1238 at 190° C., 2.16 kg load) within the range of 0.1 to 3.0 g/10 min, or can range from a low of any one of 0.1, 0.15, 0.2, or 0.22 to a high of any one of 0.30, 0.40, 0.50, 0.60, 0.70, 0.80, 0.90, 1.0, 1.5, 2.0, 2.2, 2.5, 2.7, or 3.0 g/10 min; with ranges from any foregoing low end to any foregoing high end also contemplated (provided the high end is greater than the low end). e.g., from 0.1 to 2.5 g/10 min; 0.15 to 1.0 g/10 min; or 0.2 to 0.50 g/10 min.

High load melt index (HLMI, or I₂₁, determined per ASTM D1238 at 190° C., 21.6 kg load) can be within the range from 10 to 75 g/10 min. such as from 12 to 70 g/10 min.

Density of the LCB-mLLDPE can be within the range from 0.900 to 0.940 g/cm³, such as from a low of any one of 0.905, 0.910, 0.920, or 0.925 g/cm³ to a high of any one of 0.930, 0.932, 0.933, 0.934, 0.935, or 0.940 g/cm³, with ranges from any forgoing low to any foregoing high contemplated herein (e.g., 0.910 to 0.935 g/cm³).

These LCB-mLLDPEs can be referred to as a “first mLLDPE” in compositions described herein. Some particular examples of such first mLLDPEs having the foregoing unique combination of properties include certain Enabler™ and Exceed™ XP brand polyethylenes from ExxonMobil Chemical Company, such as Exceed™ XP 6026, Enable™ 2010, Enable™ 2703, Enabler™ 3505, Enable™ 4002, and Enable™ 4009 performance polyethylenes. Other commercial examples include Dow Innate™ ST70, Dow Agility™ 2001, Dow Elite™ 5940, Dowlex™ 2038.68G, Dow Elite™ AT 6401, Dow Attane™ 4701G, Marlex™ TR130, and Nova Surpass™ 117/116.

### Narrow MWD BOCD-mLLDPEs

In some embodiments, the LLDPE can be made using a metallocene catalyst that is a substituted bulky ligand hafnium transition metal metallocene-type catalyst compound and substituted versions thereof, as disclosed in one or more of U.S. Pat. Nos. 9,181,362, 6,242,545, 7,078,467, RE40751 11,214,659, and 9,695,290; and U.S. Pub. Nos. 2015/240000, 2015/259445, and 2015/284523, the contents of which are fully incorporated by reference herein. Such catalysts can be used to produce polyethylene grades having narrow MWD with a broad orthogonal comonomer distribution (“BOCD”), which may be referred to herein as Narrow MWD BOCD-mLLDPEs.

As mentioned above, a suitable mLLDPE can have a narrow molecular weight distribution (MWD) with broad orthogonal composition distribution (BOCD). The molecular weight distribution (MWD) or (M_{w}/Mₙ) can range from about 2.0 to about 4.5, from about 2.2 to about 4.5, from about 3.0 to about 4.0, or from about 2.5 to about 4.0. The weight average molecular weight (M_{w}) can range from about 15,000 to about 400,000 g/mol, from about 20,000 to about 250,000 g/mol, from about 20,000 to about 200,000 g/mol, from about 25,000 to about 150,000 g/mol, from about 150,000 to about 400,000 g/mol, from about 200,000 to about 400,000 g/mol, or from about 250,000 to about 350,000 g/mol. The z-average molecular weight (M_{z}) to weight average molecular weight (M_{w}) ratio can be greater than about 1.5, or greater than about 1.7, or greater than about 2.0. In some embodiments, this ratio is from about 1.7 to about 3.5, from about 2.0 to about 3.0, or from about 2.2 to about 3.0.

The term “orthogonal comonomer distribution” is used herein to mean across the molecular weight range of the polymer, comonomer contents for the various polymer fractions are not substantially uniform and a higher molecular weight fraction thereof generally has a higher comonomer content than that of a lower molecular weight fraction. The term “substantially uniform comonomer distribution” is used herein to mean that comonomer content of the polymer fractions across the molecular weight range of the ethylene-based polymer vary by <10.0 wt %. In some embodiments, a substantially uniform comonomer distribution may refer to <8.0 wt %, <5.0 wt %, or <2.0 wt %. Both a substantially uniform and an orthogonal comonomer distribution may be determined using fractionation techniques such as gel permeation chromatography-differential viscometry (GPC-DV), temperature rising elution fractionation-differential viscometry (TREF-DV) or cross-fractionation techniques.

The broadness of the composition distribution of the polymer may be characterized by T₇₅-T₂₅. TREF is measured using an analytical size TREF instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm−1 using an infrared detector. The concentration of the ethylene-α-olefin copolymer in the eluted liquid may be calculated from the absorption and plotted as a function of temperature. As used herein, T₇₅−T₂₅ values refer to where T₂₅ is the temperature in degrees Celsius at which 25% of the eluted polymer is obtained and T₇₅ is the temperature in degrees Celsius at which 75% of the eluted polymer is obtained via a TREF analysis.

By “broad orthogonal comonomer distribution” or BOCD, it is meant that a substantially higher degree of short chain branching is present on longer molecular-weight polymer chains than on shorter molecular-weight polymer chains within the copolymer. Suitable narrow-MWD mLLDPEs with BOCD can have a T₇₅-T₂₅ value from 5 to 10, alternatively, a T₇₅-T₂₅ value from 5.5 to 10, and alternatively, a T₇₅−T₂₅ value from 5.5 to 8, alternatively, a T₇₅−T₂₅ value from 6 to 10, and alternatively, a T₇₅−T₂₅ value from 6 to 8, where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF).

These mLLDPEs can have a CDBI of less than about 40%, or less than about 35%, or less than about 30%, or less than about 25%. The CDBI can also range from a low of about 15%, 20%, or 25% to a high of about 30%, 35%, or 40%, and it is further noted that composition distribution is such that higher molecular weight chains of these mLLDPEs have greater wt % of comonomer than lower molecular weight chains of the mLLDPEs.

These mLLDPEs can have 70.0 wt % to 100.0 wt % of units derived from ethylene. The lower limit on the range of ethylene content may be from 70.0 wt %, 75.0 wt %, 80.0 wt %, 85.0 wt %, 90.0 wt %, 92.0 wt %, 94.0 wt %, 95.0 wt %, 96.0 wt %, 97.0 wt %, 98.0 wt %, or 99.0 wt % based on the wt % of polymer units derived from ethylene. These mLLDPEs can also have an upper ethylene limit of 80.0 wt %, 85.0 wt %, 90.0 wt %, 92.0 wt %, 94.0 wt %, 95.0 wt %, 96.0 wt %, 97.0 wt %, 98.0 wt %, 99.0 wt %, 99.5 wt %, or 100.0 wt %, based on polymer units derived from ethylene. Less than 30.0 wt % of polymer units can be derived from a C₃-C₂₀ olefin, preferably, an alpha-olefin, e.g., hexene or octene. The lower limit on the range of C₃-C₂₀ olefin-content can be 25.0 wt %, 20.0 wt %, 15.0 wt %, 10.0 wt %, 8.0 wt %, 6.0 wt %, 5.0 wt %, 4.0 wt %, 3.0 wt %, 2.0 wt %, 1.0 wt %, or 0.5 wt %, based on polymer units derived from the C₃-C₂₀ olefin. The upper limit on the range of C₃-C₂₀ olefin-content can be 20.0 wt %, 15.0 wt %, 10.0 wt %, 8.0 wt %, 6.0 wt %, 5.0 wt %, 4.0 wt %, 3.0 wt %, 2.0 wt %, or 1.0 wt %, based on polymer units derived from the C₃ to C₂₀ olefin.

These mLLDPEs can have a density in accordance with ASTM D-4703 and ASTM D-1505/ISO 1183 of from about 0.900 g/cm³ to about 0.940 g/cm³, from about 0.910 g/cm³ to about 0.935 g/cm³, from about 0.900 g/cm³ to about 0.930 g/cm³, from about 0.900 g/cm³ to about 0.925 g/cm³, from about 0.900 g/cm³ to about 0.923 g/cm³, from about 0.900 g/cm³ to about 0.920 g/cm³, from about 0.912 g/cm³ to about 0.919 g/cm³, from about 0.912 g/cm³ to about 0.918 g/cm³, from about 0.914 g/cm³ to about 0.918 g/cm³, or from about 0.915 g/cm³ to about 0.918 g/cm³.

These mLLDPEs can have a melt index (MI) or (I_{2.16}) as measured by ASTM D-1238-E (190° C./2.16 kg) of about 0.1 g/10 min to about 5.0 g/10 min, about 0.1 g/10 min to about 3.0 g/10 min, about 0.1 g/10 min to about 2.0 g/10 min, about 0.1 g/10 min to about 1.2 g/10 min, about 0.2 g/10 min to about 1.5 g/10 min, about 0.2 g/10 min to about 1.1 g/10 min, about 0.3 g/10 min to about 1.0 g/10 min, about 0.4 g/l 0 min to about 1.0 g/10 min, about 0.5 g/10 min to about 1.0 g/10 min, about 0.6 g/10 min to about 1.0 g/10 min, about 0.7 g/10 min to about 1.0 g/10 min, or about 0.75 g/10 min to about 0.95 g/10 min.

These mLLDPEs can have a melt index ratio (MIR) (I_{21.6}/I_{2.16}) (as defined below) of from about 20.0 to about 35.0, from about 22 to about 38, from about 20 to about 32, from about 25 to about 32 or from about 28 to about 31.

These mLLDPEs can also have at least a first peak and a second peak in a comonomer distribution analysis, wherein the first peak has a maximum at a log(M_{w}) value of from 4.0 to 5.4, or from 4.3 to 5.0, or from 4.5 to 4.7; and a TREF elution temperature of from 70.0° C. to 100.0° C., or from 80.0° C. to 95.0° C., or from 85.0° C. to 90.0° C. The second peak in the comonomer distribution analysis has a maximum at a log(M_{w}) value of 5.0 to 6.0, 5.3 to 5.7, or 5.4 to 5.6; and a TREF elution temperature of 40.0° C. to 60.0° C., 45.0° C. to 60.0° C., or 48.0° C. to 54.0° C.

In any of the embodiments described above, a suitable mLLDPE can have a narrow MWD with broad orthogonal composition distribution with one or more of the following properties: a melt index (MI) (190° C./2.16 kg) of from about 0.1 g/10 min to about 5.0 g/10 min; a melt index ratio (MIR) of from about 25 to about 32; a M_{w} of from about 20,000 to about 200,000 g/mol; a M_{w}/Mₙ of from about 2.0 to about 4.5; and a density of from about 0.900 g/cm³ to about 0.940 g/cm³.

Commercially available examples of such second mLLDPEs having the foregoing unique combination of properties include Exceed XP™ resins from ExxonMobil Chemical Company.

### Broad-BOCD-mLLDPE

In some embodiments, the LLDPE can be made using a dual metallocene catalyst system comprising a bridged bis-cyclopentadienyl Group 4 metal catalyst and an unbridged bis-cyclopentadienyl Group 4 metal catalyst, as disclosed in one or more of U.S. Pat. Nos. 10,611,867, 10,808,053, and 11,274,196; WIPO Publication WO2019/108327; and U.S. Pub. No. 2021/0238321, the contents of which are fully incorporated by reference herein (and which further include description of relevant mLLDPEs). Such catalyst systems can produce polyethylene grades having broad MWD with a broad orthogonal comonomer distribution (“BOCD”), which are referred to herein as a “Broad-BOCD-mLLDPE.”

The MWD (weight average molecular weight, Mw, divided by number-average molecular weight, Mn) of these mLLDPEs can range, for example, from about 6.0 to about 10.0, from about 6.4 to about 9.5, from about 6.0 to about 9.0, from about 6.5 to about 10.0, or from 7.0 to 8.5.

These mLLDPEs can have a density in accordance with ASTM D-4703 and ASTM D-1505/ISO 1183 of from about 0.900 g/cm³ to about 0.945 g/cm³, such as from about 0.910 to about 0.935 g/cm³, from about 0.910 g/cm³ to about 0.930 g/cm³, from about 0.900 g/cm³ to about 0.925 g/cm³, from about 0.900 g/cm³ to about 0.933 g/cm³, from about 0.900 g/cm³ to about 0.920 g/cm³, from about 0.912 g/cm³ to about 0.919 g/cm³, from about 0.912 g/cm³ to about 0.938 g/cm³, from about 0.914 g/cm³ to about 0.928 g/cm³, or from about 0.915 g/cm³ to about 0.938 g/cm³. Any foregoing low end can be combined with any foregoing high end, provided the high is greater than the low (e.g., 0.912 to 0.915 g/cm³, or 0.910 to 0.928 g/cm³).

These mLLDPEs can have a branching index (as defined herein) of g′ᵥᵢₛ≥0.95, ≥0.96, ≥0.97, ≥0.98, ≥0.99 or 1.0, for example, from 0.95 to 1.0, from 0.96 to 1.0, from 0.97 to 0.995, from 0.98 to 0.998, from 0.98 to 0.99, from 0.99 to 1.0 Preferably, the g′ᵥᵢₛ is ≥0.98 or ≥0.995.

Suitable Broad MWD BOCD-mLLDPEs can have a BOCD characterized in that the T₇₅−T₂₅ value is 15° C. or greater, 17.5° C. or greater, 20° C. or greater, 25-C or greater, 30° C. or greater, 35° C. or greater, 40° C. or greater, or 45° C. or greater, wherein T₂₅ is the temperature (° C.) at which 25% of the eluted polymer is obtained and T₇₅ is the temperature (° C.) at which 75% of the eluted polymer is obtained in a TREF experiment. For instance, the T₇₅−T₂₅ value for these Broad MWD BOCD-mLLDPEs can be within the range from 30° C. or 35° C. to 55° C., 55° C., 60° C., or 65° C. (with ranges from any foregoing low end to any foregoing high end contemplated).

These mLLDPEs can have a CDIBI of less than about 40%, or less than about 35%, or less than about 34%, or less than about 33%. The CDBI can also range from a low of about 15%, 20%, or 25% to a high of about 35%, 37%, or 40%, and the composition distribution (or comonomer distribution) is such that the mLLDPE has a greater amount (wt %) of comonomer incorporated in its longer (higher molecular weight) polymer chains than the amount (wt %) of comonomer incorporated in its shorter (lower molecular weight) polymer chains. As noted already, GPC analytical methods are suitable for determining relative amounts of comonomer incorporation at high and low polymer chains. For an example of some such polymers and discussion of the incorporation of comonomer along their chains, see, e.g., PCT/US2021/072552, filed 22 Nov. 2021, entitled “Medium Density Polyethylene Compositions with Broad Orthogonal Composition Distribution”, and hereby incorporated by reference.

### Modifiers

The modifier preferably is an ethylene copolymer elastomeric modifier. The modifier comprises at least 70 wt % ethylene-derived units (such as within the range from 70, 71, or 72 wt % to 78, 79, or 80 wt % ethylene-derived units) and from 20-30 wt % (such as from 21, 22, 23 or 24 wt % to 25, 26, 27, 28, 29, or 30 wt %) of units derived from a C₃ to C₂₀ (preferably C₃ to C₁₀) α-olefin comonomer, such as propylene. Preferred modifiers of some embodiments may, for instance, be ethylene-propylene (EP) elastomeric copolymers. In further embodiments, the modifier optionally further includes 0.1 to 5 wt % of units derived from a cyclic-diene comonomer, such that the modifier of such embodiments may for example be an ethylene terpolymer elastomer, with preferred examples of such embodiments including EPDM (ethylene-propylene-diene monomer) elastomers, such as those derived from ethylene, propylene, and cyclic-diene.

Dienes may be conjugated or non-conjugated. For example, non-conjugated dienes can be 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; 5-vinyl-2-norbornene (VNB); dicyclopentadiene (DCPD); and combinations thereof. For example, the diene, if present, is preferably ENB and/or VNB.

In some embodiments employing cyclic diene, the cyclic-diene monomer is selected from the group consisting of dicyclopentadiene (DCPD), norbornadiene (NBD), 5-vinyl-2-norbornene (VNB), ethylidene norbornene (ENB), derivatives thereof, and combinations thereof, or is VNB.

In some embodiments, the α-olefin comonomer units can be derived from propylene, 1-butene, 1-hexene, and/or 1-octene; the comonomer unit is preferably propylene.

Thus, the modifier of some embodiments may comprise units derived from ethylene, one or more C₃-C₂₀ α-olefin comonomers, and optionally one or more cyclic-diene comonomers, such that the α-olefin comonomer-derived units are present within the range from 20-30 wt % (such as 20, 21, 22, 23, or 24 wt % to 25, 26, 27, 28, 29, or 30 wt %); the cyclic-diene comonomer-derived units are present within the range from 0 to 5 wt % (such as 0, 0.1, 0.2, 0.3, or 0.5 to 1, 1.5, 2, 2.5, 3, 4, or 5 wt %); with the balance ethylene-derived units (all wt % s on the basis of total molecular weight of the modifier). Ranges from any foregoing low end to any foregoing high end are contemplated (e.g., 21 to 25 wt % α-olefin comonomer-derived units; 0.1 to 5 wt % cyclic-diene comonomer-derived units). For example, the modifier can be an ethylene copolymer elastomeric modifier having 70-80 wt % ethylene-derived content, 20-30 wt % C₃ to C₁₀ α-olefin comonomer-derived content, and optionally 0.1 to 5 wt % (such as 0.1 to 1 wt % or 2 wt %) cyclic-diene comonomer-derived content.

Monomer distribution in the modifier may be random, but it is also anticipated that the modifier can have block content with respect to monomer distribution.

The modifier can have a density of from about 0.85 g/cm³ to about 0.926 g/cm³, from about 0.85 g/cm³ to about 0.923 g/cm³, or from about 0.87 g/cm³ to about 0.91 g/cm³, such as about 0.88 g/cm³. Density of the modifier is determined using chips cut from plaques compression molded in accordance with ASTM D-1928 Procedure C, aged in accordance with ASTM D-618 Procedure A, and measured as specified by ASTM D-1505.

The modifier preferably has long-chain branching. The presence of long-chain branching can be inferred from various rheological and/or viscometric parameters.

For instance, the modifier can be characterized in terms of its Mooney Viscosity Units (test method and further details described below in connection with the “Modifier Test Methods” section); for example, it can have one or more of the following: (i) Mooney viscosity within the range from 10 to 40 MU (ML, 1+4 @100° C.), such as within the range from 10, 12, 14, 16, 18, or 20 MU to 25, 27, 28, 29, 30, 32, 35, 37, or 40 MU; (ii) Mooney Relaxation Area (MLRA) within the range from 100 to 500 MU-sec, such as within the range from 100, 130, 150, 175, or 200 MU-sec to 250, 300, 350, 400, 450, or 500 MU-sec; and (iii) a corrected Mooney relaxation area (cMLRA) of 400 MU-sec or more, 600, 800, or 1000 MU-sec or more.

Also, or instead, the modifier can be characterized in terms of its rheology. For instance, the modifier can in various embodiments have one or more of the following characteristics:
Phase angle (also referred to as loss angle) δ, measured at complex modulus G*=10⁵ Pa, within the range from 15-45°, such as 20° to 30°, 35°, 40°, or 45°, or alternatively from 0-45° (i.e., 45° or less) or 0-35° (i.e., 35° or less);
Tan(δ) (measured at a frequency of 0.245 Rad/s) of 0.9 or less, 0.8 or less, 0.6 or less, 0.5 or less, or 0.4 or less; in other embodiments, Tan(δ) may be within the range from 0.400 to 0.800, such as from a low of any one of 0.400, 0.425, or 0.430 to a high of any one of 0.500, 0.550, 0.575, 0.600, 0.650, 0.675, 0.700, 0.750, or 0.800;
STR (shear thinning ratio, η*(0.1 Rad/s)/η*(128 Rad/s)) within the range from 50 to 500, preferably 100 to 400, such as within the range from any one of 50, 75, or 100 to 200, 250, 300, 350, 400, 450, or 500.

Yet further, long chain branching in the modifier can be seen through a Van Gurp Palmen (VGP) plot of loss angle vs. G*, such as the one shown in FIG. 6 of US2020/0223951, which is incorporated by reference herein. In that figure, one can see an example of 3 ethylene-propylene-optional diene copolymers in accordance with the modifier of the present disclosure, all having plateaus in the VGP plot, which is characteristic of long chain branching.

Optionally, the modifier can further be characterized on the basis of its molecular weight characteristics; in particular, the modifier can include any one or more of the following:
Number average molecular weight (Mn), preferably determined by GPC-IR as described below, within the range from 8,000 to 70,000 g/mol, preferably 10,000 to 40,000 g/mol, such as within the range from 8,000; 10,000; or 12,000 g/mol to 15.000; 17,500; 20,000; 22,500; 25,000; 30,000; 40,000; 50,000; 60,000; or 70,000 g/mol, with ranges from any foregoing low to any foregoing high contemplated.
Weight average molecular weight (Mw), preferably determined by GPC-LS as described below, within the range from 100,000 g/mol to 800,000 g/mol, preferably from 120,000 g/mol to 500,000 g/mol, such as from a low of any one of 100,000; 115,000; 120,000; or 125,000 g/mol to a high of any one of 175,000; 200,000; 225,000; 250,000; 275,000; 300,000; 350,000; 400,000; 450,000; 500,000; 600,000; 700,000 or 800,000 g/mol, with ranges from any foregoing low to any foregoing high contemplated.
Z-average molecular weight (Mz), preferably also determined by GPC-LS, within the range from 300,000 to 3,000,000 g/mol, preferably from 325,000 g/mol to 2,800,000 g/mol; such as within the range from a low of any one of 300,000; 325,000; 350,000; or 400,000 g/mol to a high of any one of 500,000; 750,000; 1,000,000; 1,500,000; 2,000,000; 2,500,000; 2,800,000; or 3,000,000 g/mol, with ranges from any foregoing low to any foregoing high contemplated.
Molecular weight distribution (MWD, Mw_{LS}/Mn_{IR}) within the range from 5, 6, 7, or 8 to 11, 12, 15, 20, or 30.

Ethylene alpha-olefin diene terpolymers of the present disclosure may be made by any suitable polymerization method including solution polymerization, slurry polymerization, and gas phase polymerization using supported or unsupported catalyst systems, such as a system incorporating a metallocene catalyst. Non-limiting examples of metallocene catalysts and catalyst systems include those described in, U.S. Pat. No. 7,511,106, which is fully incorporated herein by reference.

In at least one embodiment, a procedure suitable for preparing ethylene alpha-olefin diene terpolymers is as follows. The catalysts used are VOCl₃ (vanadium oxytrichloride) or VCl₄ (vanadium tetrachloride). The co-catalyst is chosen from (i) ethyl aluminum sesquichloride (SESQUI), (ii) diethyl aluminum chloride (DEAC), and (iii) equivalent mixture of diethyl aluminum chloride and triethyl aluminum (TEAL). As shown in U.S. Pat. No. 5,763,533 (FIG. 8), the choice of co-catalyst influences the composition distribution in the polymer. An elastomer with a broader composition distribution is expected to provide better tensile strength in a cable coating compound. The polymerization is carried out in a continuous stirred tank reactor at 20-65° C. at a residence time of 6-15 minutes and a pressure of 7 kg/cm². The concentration ratio of vanadium to alkyl is from 1 to 4 to 1 to 8. About 0.3 to 1.5 kg of polymer is produced per gram of catalyst fed to the reactor. The polymer concentration in the hexane solvent is in the range of 3-7% by weight. As reported in U.S. Pat. No. 5,763,533, the synthesis of ethylene, alpha-olefin, vinyl norbornene polymers was conducted both in a laboratory pilot unit (output about 4 kg/day), a large scale semi works unit (output 1 T/day), and a commercial scale production unit (output 200,000 kg/day). Useful modifiers in the present invention can be made by any suitable means, but in any embodiment, the methods used in U.S. Pat. No. 7,511,106 are used, most preferably, a solution metallocene process. Examples of commercially available modifiers include certain Vistalon™ EPDM grades from ExxonMobil Chemical Company, and in particular those having VNB-derived content, such as Vistalon™ 1703P EPDM More generally, such embodiments of the modifier can be characterized as ethylene-propylene-diene copolymers having VNB-derived content.

In yet other embodiments, the modifier can be an ethylene-propylene copolymer, and have substantially no diene-derived units (e.g., no VNB, ENB, or the like), or can be an ethylene-propylene-diene copolymer having ENB-derived units but substantially no VNB-derived units. Particular examples of such EP elastomeric copolymer are described in US2020/0223951 as “Lower-Mooney Copolymer Compositions”, and reference is made to Paragraphs [0101]-[0118] of that publication (which description is incorporated by reference herein) for discussion on suitable methods for making such elastomeric copolymers.

### Test and Measurement Methods for Modifiers

Some measurement methods for the modifiers may differ from those used in connection with the polyethylene polymers described above. Unless indicated otherwise, measurement methods for modifiers described herein should be determined by following the description at Paragraphs [0136]-[0162] of US2020/0223951, which description is incorporated by reference herein. Furthermore, in the context of modifiers, one modification to the test methods as described herein should also be used: where DRI, IR, and/or LS measurements conflict, LS measurements should be used for Mw and Mz, while DRI or IR measurements should be used for Mn (if nothing specified for Mn, use IR measurements). And, although MWD (polydispersity) is taken as Mw/Mn, where DRI, LS, and/or IR measurements conflict, MWD should be determined as Mw (measured by LS)/Mn (measured by IR), or Mw_{LS}/Mn_{IR}.

### Modified Polyethylene

In at least one embodiment, processes of the present disclosure produce modified polyethylenes including the first polyethylene and the second polyethylene. The modified polyethylene is the product of the combination of 90-99.9 wt % of a polyethylene and from 0.10-10 wt % of a modifier, wherein the weight percentages are based on the combined weight of the polyethylene and the modifier. Preferably, the amount of modifier is present in the modified polyethylene in the range of from a lower limit of 0.2, 0.3, or 0.5 wt % to an upper limit of 1.0, 1.25, 1.5, 1.75, 2.0, 2.5, 3, or 5 wt %, with ranges from any foregoing low to any foregoing high contemplated.

In at least one embodiment, the melt strength of a modified polyethylene may be from about 1 to about 100 cN, about 1 to about 50 cN, about 1 to about 25 cN, about 3 to about 15 cN, about 4 to about 12 cN, or about 5 to about 10 cN, or about 5 to about 15 cN, when measured at 190° C. In some embodiments, the modified polyethylene has a melt strength of at least about 5 cN, at least about 10 cN, or at least about 15 cN, and 30 up to about 20 cN, when measured at 190° C.

Compositions of the present disclosure may be produced by mixing the first polyethylene polymer with the ethylene alpha-olefin diene terpolymer, by connecting reactors together in series to make reactor blends or by using more than one catalyst in the same reactor to produce multiple species of polymer. The polymers can be mixed together prior to being put into an extruder or may be mixed in an extruder.

The compositions may be formed by dry blending the individual polymers and subsequently melt mixing in a mixer, or by mixing the polymers together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the composition, in one or more components of the composition, and/or in a product formed from the composition, such as a film, as desired. Such additives can include, for example: fillers; antioxidants (e.g., hindered phenolics such as IRGANOX™ 1010 or IRGANOX™ 1076 available from BASF); phosphites (e.g., IRGAFOS™ 168 available from BASF); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica, fillers; and talc.

Production of the modified polyethylene includes the extrusion of a molten composition which is a mixture or blend of a polyethylene and a modifier. When referring to “a polyethylene,” “a modifier,” or “molten composition,” this includes the possibility of having a blend of two or more polymers and or modifiers fitting that description. They can be blended together by any known method such as dry blending of pellets/granules of the material followed by melt extrusion to form an intimate blend suitable for forming blown films, foamed articles such as plates and cups, and other useful articles. The blending can take place prior to forming films or other articles, thus forming pellets or granules of the blend that can be shipped and/or stored, or the blending can take place in the melt blending apparatus (e.g., screw extruder) used in the film forming or foamed article process equipment. In either stage, other additives can also be added that are common in the art such as antioxidants, slip agents, etc.

In another aspect, the modified polyethylene may be blended in solution by any suitable means by using a solvent that dissolves both components to a significant extent. The blending may occur at any temperature or pressure where the modifier and the polyethylene polymer remain in solution. Conditions include blending at high temperatures, such as 10° C. or more, such as 20° C. or more over the melting point of the polyethylene polymer. Such solution blending would be particularly useful in processes where a polyethylene polymer is made by solution process and the modifier is added directly to the finishing train, rather than added to the dry polymer in another blending step altogether. Such solution blending would also be particularly useful in processes where a polyethylene polymer is made in a bulk or high pressure process where both the polymer and the modifier were soluble in the monomer. As with the solution process, the second polyethylene is added directly to the finishing train rather than added to the dry polymer in another blending step altogether.

Thus, in the cases of fabrication of articles using methods that involve an extruder, such as injection molding or blow molding, any means of combining the first polyethylene polymer and second polyethylene polymer to achieve the desired composition serve equally well as fully formulated pre-blended pellets, since the forming process can include a re-melting and mixing of the raw material; example combinations include simple blends of neat polymer pellets (and optional additive(s)), neat polymer granules, and neat polymer pellets and pre-blended pellets. Here, “pre-blended pellets” means pellets of a modified polyethylene. In the process of compression molding, however, little mixing of the melt components occurs, and pre-blended pellets would be preferred over simple blends of the constituent pellets (or granules). Those skilled in the art will be able to determine the appropriate procedure for blending of the polymers to balance the need for intimate mixing of the component ingredients with the desire for process economy.

### End Uses

Any of the foregoing polymers and compositions in combination with optional additives (see, for example, U.S. Patent Application Publication No. 2016/0060430, paragraphs [0082]-[0093]) may be used in a variety of end-use applications. Such end uses may be produced by methods known in the art. End uses include polymer products and products having specific end-uses. Exemplary end uses are films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

### Film Performance

The present inventors have discovered that films from blends of certain polyethylenes and certain modifiers exhibit a new and useful balance of properties, including but not limited to increasing the maximum output of film production equipment by as much as 15 percent or more while maintaining or improving other film properties such as stiffness, tear resistance, tensile strength, and sealing performance of a polyethylene with the addition of modifier to a polyethylene as 10 percent or less of the total composition. Additionally, optical properties, such as haze, of polyethylene are dramatically improved through the addition of modifier as 10 percent or less of the total composition. Comparisons of performance characteristics below are based on comparison of a given film production process using a modified polyethylene to the same film production process using the corresponding neat polyethylene. The corresponding neat polyethylene corresponding to a particular modified polyethylene means the polyethylene that when blended with a specified amount of modifier would yield the modified polyethylene.

In some embodiments, film production rates are increased by 1% or more, 5% or more, 10% or more, 20% or more, 30% or more, 40% or more, or 50% or more, while maintaining or improving other film properties such as stiffness, tear resistance, tensile strength, and sealing performance when comparing a neat polyethylene to the corresponding modified polyethylene.

In some embodiments, independently or in combination with the above film parameters, a film made from the modified polyethylene has a measured haze, according to ASTM D-1003, of 80% or less, 60% or less, 40% or less, or 20% or less of the haze measured for the same film made from the corresponding neat polyethylene.

In some embodiments, independently or in combination with the above film parameters, a film made from the modified polyethylene has a strength hardening ratio (SHR) of 1% or more, 5% or more, 10% or more, 20% or more, 30% or more, 40% or more, or 50% or more, greater than the SHR of the same film made from the corresponding neat polyethylene.

In some embodiments, independently or in combination with the above film parameters, a film made from the modified polyethylene has a puncture force of 90% or more, 95%, or more, 97% or more, 99% or more, or 100% or of the value measured for a film produced by the same blown film extrusion process using the neat polyethylene in place of the modified polyethylene.

In some embodiments, independently or in combination with the above film parameters, a film made from the modified polyethylene has a puncture break energy, in accordance with a modified ASTM D5748, of 90% or more, 95% or more, 97% or more, 99% or more, or 100% or of the value measured for a film produced by the same blown film extrusion process using the neat polyethylene in place of the modified polyethylene.

In some embodiments, independently or in combination with the above film parameters, a film made from the modified polyethylene has an averaged TD 1% secant modulus (M), according to ASTM D882, of 1% or more, 5% or more, 10% or more, 20% or more, 30% or more, 40% or more, or 50% or more, greater than the averaged TD 1% secant modulus (M), of the same film made from the corresponding neat polyethylene.

In some embodiments, independently or in combination with the above film parameters, a film made from the modified polyethylene has an averaged MD 1% secant modulus (M), according to ASTM D882, of 1% or more, 5% or more, 10% or more, 20% or more, 30% or more, 40% or more, or 50% or more, greater than the averaged MD 1% secant modulus (M), of the same film made from the corresponding neat polyethylene.

In some embodiments, independently or in combination with the above film parameters, a film made from the modified polyethylene has a MD Elmendorf tear strength, according to ASTM D1922, of 1% or more, 5% or more, 10% or more, 20% or more, 30% or more, 40% or more, or 50% or more, greater than the MD Elmendorf tear strength of the same film made from the corresponding neat polyethylene.

In some embodiments, independently or in combination with the above film parameters, a film made from the modified polyethylene has a Dart Drop Impact (or Dart F50 or Dart Drop Impact Strength (DIS), reported in grams (g) or grams per mil (g/mil), in accordance with ASTM D1709, method A, of 90% or more, 95% or more, 100% or more, 110% or more, or 120% or more, of the Dart Drop value measure for the same film made from the corresponding neat polyethylene.

### Test Methods

The properties cited herein were determined in accordance with the following test procedures (except that where the below procedures conflict with the procedures set forth above for the modifiers, the test methods for modifiers should be used in determining properties of the modifiers).

Unless otherwise indicated, the distribution and the moments of molecular weight (M_{w}, Mₙ, M_{w}/Mₙ, etc.—reported in g/mol unless otherwise noted), the comonomer content (C₂, C₃, C₆, etc.) and the branching index (g′ᵥᵢₛ) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 20 μL. The whole system including transfer lines, columns, and detectors are contained in an oven maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples. The TCB densities used in concentration calculation are 1.463 g/ml at room temperature and 1.284 g/ml at 145° C. The sample solution concentration is from 0.2 to 2.0 mg/ml, with lower concentrations being used to for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are for the test samples. In this method, α_{PS}=0.67 and K_{PS}=0.000175 while α and K are for other materials as calculated and published in literature (Sun, T. et al. Macromolecules 2001, 34, 6812), except that for purposes of the present disclosure, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w2 = f * SCB / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits}$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH₃end/1000TC) is obtained by weight-averaging the chain-end correction over the molecular-weight range. Then

$$w 2 b = f * bulk {CH}_{3} / 1000 TC$$

$$bulk SCB / 1000 TC = bulk {CH}_{3} / 1000 TC - bulk CH 3 end / 1000 TC$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{ΔR ( θ )} = \frac{1}{MP ( θ )} \to 2 {A}_{{2}_{}} c$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{{o}^{=}} \frac{4 {π}^{2} {{n}^{2} ( dn / dc )}^{2}}{{λ}^{1} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂ 0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{ₚₛ}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {c}_{i} [ η ]}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{a}} ,$$

where M_{V} is the viscosity-average molecular weight based on molecular weights determined by LS analysis and the K and α are for the reference linear polymer, which are, for purposes of the present disclosure, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.00018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Melt Index (MI, also referred to as I₂) is measured according to ASTM D1238 at 190° C., under a load of 2.16 kg unless otherwise noted. The units for MI are g/10 min or dg/min. High Load Melt Index (HLMI, also referred to as I₂₁) is the melt flow rate measured according to ASTM D-1238 at 190° C., under a load of 21.6 kg. The units for HLMI are g/10 min or dg/min.

Melt Index Ratio (MIR) is the ratio of the high load melt index to the melt index, or I₂₁/I₂.

Density is measured by density-gradient column, as described in ASTM D1505, on a compression-molded specimen that has been slowly cooled to room temperature (i.e., over a period of 10 minutes or more) and allowed to age for a sufficient time that the density is constant within +/−0.001 g/cm³. The units for density are g/cm³.

Composition Distribution Breadth Index (CDBI) was measured by the procedure described in PCT publication WO 93/03093, published Feb. 18, 1993, specifically columns 7 and 8 as well as in Wild et al. J. Poly. Sci., Poly. Phys. Ed., Vol. 20, p. 441 (1982) and U.S. Pat. No. 5,008,204, including that fractions having a weight average molecular weight (Mw) below 15,000 are ignored when determining CDBI.

The broadness of the composition distribution of the polymer may also be characterized by T₇₅−T₂₅. It is readily determined utilizing well known techniques for isolating individual fractions of a sample of the copolymer. One such technique is Temperature Rising Elution Fractionation (TREF), as described in Wild, et al., J. Poly. Sci., Poly. Phys. Ed., Vol. 20, pg. 441 (1982) and U.S. Pat. No. 5,008,204. For example, TREF may be measured using an analytical size TREF instrument (Polymerchar. Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min. 20 Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm−1 using an infrared detector. The concentration of the ethylene-olefin copolymer in the eluted liquid may be calculated from 25 the absorption and plotted as a function of temperature. As used herein, T₇₅−T₂₅ values refer to where T₂₅ is the temperature in degrees Celsius at which 25% of the eluted polymer is obtained, and T₇₅ is the temperature in degrees Celsius at which 75% of the eluted polymer is obtained via a TREF analysis.

Dynamic shear melt rheological data were measured with an Advanced Rheometrics Expansion System (ARES) using parallel plates (diameter=25 mm) in a dynamic mode under nitrogen atmosphere. For all experiments, the rheometer was thermally stable at 190° C. for at least 30 minutes before inserting compression-molded sample of resin onto the parallel plates. To determine the samples' viscoelastic behavior, frequency sweeps in the range from 0.01 to 385 rad/s were carried out at a temperature of 190° C. under constant strain. Depending on the molecular weight and temperature, strains of 10% and 15% were used and linearity of the response was verified. A nitrogen stream was circulated through the sample oven to minimize chain extension or cross-linking during the experiments. All the samples were compression molded at 190° C. and no stabilizers were added. A sinusoidal shear strain is applied to the material if the strain amplitude is sufficiently small the material behaves linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90. The shear thinning slope (STS) was measured using plots of the logarithm (base ten) of the dynamic viscosity versus logarithm (base ten) of the frequency. The slope is the difference in the log (dynamic viscosity) at a frequency of 100 s−1 and the log (dynamic viscosity) at a frequency of 0.01 s−1 divided by 4. Dynamic Viscosity is also referred to as complex viscosity or dynamic shear viscosity. The dynamic shear viscosity (η*) versus frequency (ω) curves were fitted using the Cross model (see, for example, C. W. Macosco, Rheology: Principles, Measurements, and Applications, Wiley-VCH, 1994):

$${η}^{*} = \frac{{η}_{0}}{1 + {( λ ω )}^{1 - n}}$$

The three parameters in this model are: η₀, the zero-shear viscosity; λ, the average relaxation time; and n, the power-law exponent. The zero-shear viscosity is the value at a plateau in the Newtonian region of the flow curve at a low frequency, where the dynamic viscosity is independent of frequency. The average relaxation time corresponds to the inverse of the frequency at which shear-thinning starts. The power-law exponent describes the extent of shear-thinning, in that the magnitude of the slope of the flow curve at high frequencies approaches 1−n on a log(η*)−log(ω) plot. For Newtonian fluids, n=1 and the dynamic complex viscosity is independent of frequency. For the polymers of interest here, n<1, so that enhanced shear-thinning behavior is indicated by a decrease in n (increase in 1−n).

Extensional rheology is performed at 150° C. using a Sentmanat Extensional Rheometer-2 (SER-2) mounted in a rotational rheometer MCR 501 (Anton-Paar). The SER-2 consists of two counter-rotating drums on which the film sample is mounted at 150° C. and secured with pins. One of the drums is connected to the rheometer torque transducer and rotational motor, which imposes pure uniaxial extensional deformation on the sample. Values of the imposed strain rate and measured torque are used to calculate the extensional viscosity. The film specimens are prepared by compression molding at 200° C. The specimen typical dimensions are 12.7 mm×12.7 mm×0.5 mm. Additionally, the linear viscoelastic (LVE) envelope is obtained from start-up of steady shear experiments with a cone and plate fixture, and using Trouton's rule in extension transient mode, h=3h, where h7 is the extensional viscosity, and h is the shear viscosity.

SHR or strain hardening ratio is defined as:

$$SHR = \frac{{η}_{E , Peak}}{{η}_{E , LVE}}$$

Where η_{E,Peak} is the peak extension viscosity in strain hardening region; and η_{E,Peak} is the extension viscosity linear viscoelastic region.

Melt strength of a modified polyethylene at 190° C. is determined with a Gottfert Rheotens Melt Strength Apparatus. To determine melt strength, a modified polyethylene melt strand extruded from the capillary die is gripped between two counter-rotating wheels on the apparatus. The take-up speed is increased at a constant acceleration of 2.4 mm/sec². The maximum pulling force (in the unit of cN) achieved before the strand breaks or starts to show draw-resonance is determined as the melt strength. The draw ratio is defined as the ratio between take up speed at maximum pulling force and the extrusion rate at the die exit. The temperature of the rheometer is set at 190° C. The capillary die has a length of 30 mm and a diameter of 2 mm. The modified polyethylene melt is extruded from the die at a speed of 18 mm/sec. The distance between the die exit and the wheel contact point should be 122 mm.

Where applicable, the film properties and descriptions below are intended to encompass measurements in both the machine and transverse directions. Such measurements are reported separately, with the designation “MD” indicating a measurement in the machine direction, and “TD” indicating a measurement in the transverse direction.

Gauge, reported in mils, was measured using a Measuretech Series 200 instrument. The instrument measures film thickness using a capacitance gauge. For each film sample, ten film thickness data points were measured in a transverse direction, on each inch of film as the film was passed through the gauge. From these measurements on each inch of the film, an average gauge measurement was determined and reported.

Elmendorf Tear, reported in grams (g) or grams per mil (g/mil), was measured as specified by ASTM D-1922.

Tensile Strength at Yield, reported in pounds per square inch (lb/in² or psi), was measured as specified by ASTM D-882.

Tensile Strength at Break, reported in pounds per square inch (lb/in² or psi), was measured as specified by ASTM D-882.

Elongation at Yield, reported as a percentage (%), was measured as specified by ASTM D-882.

Elongation at Break, reported as a percentage (%), was measured as specified by ASTM D-882.

1% Secant Modulus (M), reported in pounds per square inch (lb/in² or psi), was measured as specified by ASTM D-882.

Haze, reported as a percentage (%), was measured as specified by ASTM D-1003.

Clarity, reported as a percentage (%), was measured as specified by ASTM D-1746.

Dart F₅₀, or Dart Drop Impact or Dart Drop Impact Strength (DIS), reported in grams (g) and/or grams per mil (g/mil), was measured as specified by ASTM D-1709, method A, unless otherwise specified.

“Puncture Force/Energy”—A probe puncture energy test was completed using an Instron Universal tester that records a continuous reading of the force (stress) and penetration (strain) curve. A 6 inch by 6 inch (15 cm by 15 cm) film specimen was securely mounted to a compression load cell to expose a test area 4 inches in diameter (10 cm). Two HDPE slip sheets each 2 inches by 2 inches (5 cm by 5 cm) and each approximately 0.25 mils (6.35 μm) thick were loosely placed on the test surface. A ¾ inch (1.875 cm) diameter elongated matte finished stainless steel probe, traveling at a constant speed of 10 inch/minute (25 cm/min) was lowered into the film, and a stress/strain curve was recorded and plotted. The “puncture force” was the maximum force (pounds) encountered or pounds per mil (lb/mil) encountered. The machine was used to integrate the area under the stress/strain curve, which is indicative of the energy consumed during the penetration to rupture testing of the film, and is reported as “puncture energy” (inch pounds) and/or inch-pounds per mil (in-lb/mil). The probe penetration distance was not recorded in these tests, unless specifically states to the contrary.

Where any of the above properties are reported in pounds per square inch, grams per mil, or in any other dimensions that are reported per unit area or per unit thickness, the ASTM methods cited for each property have been followed except that the film gauge was measured based on ASTM D-374, method C.

### Examples

It is to be understood that while embodiments have been described in conjunction with the specific embodiments thereof, the foregoing description is intended to illustrate and not limit the scope of the present disclosure. Other aspects, advantages and modifications will be apparent to those skilled in the art to which the present disclosure pertains.

The ethylene-propylene-vinylidene norbornene terpolymer “A” used as modifier in the examples is made according to U.S. Pat. No. 7,511,106 having 79 wt % ethylene derived units by weight of the terpolymer, 0.96 wt % of VNB based on the weight of the terpolymer, where the remainder is propylene derived units. It has density of 0.885 g/cm³ and characteristic long chain branching (loss angle (δ) at G*=10⁵ of 30.3; tan(δ) @0.245 rad/s of 0.731, and STR of 110), as well as Mooney Viscosity (1+4, 125° C.) of 25 MU. The terpolymer is also blended with 0.16 wt % of Irganox™ 1076 antioxidant.

In comparative samples C-1 to C-5, and inventive samples I-1 to I-10, the base resins B-F are Exceed™ Polyethylene 1012HA, 2018HA, 3518CB, 4518PA and 7518CB, performance PE available from ExxonMobil Chemical Company (Houston, Texas). To prepare inventive samples I-1 to I-6, pellets of base resins and terpolymer modifier “A” was premixed in solid state and extruded on a 57 mm Werner & Pfleiderer twin screw extruder, i.e. ZSK-57. A 1″ Haake twin screw extruder with an L/D of 15 followed by a strand pelletizer was used to prepared examples I-7 to I-10. Some of the properties and processing conditions of the sample blends are reported in Table 1 below. Further, an antioxidant package was added into all the compounded compositions. The antioxidant consists of 0.05 wt % of Irganox™1076 and 0.1 wt % of Irgafos™ 168 (available from BASF). The extruder temperature setting was at 180/185/190/195° C. The concentration is the weight percent of the final blend. Some properties and processing conditions of

TABLE 1

| | | | | Melt | Draw | η_{E} | η_{E} | | Zero | Relaxation |
|---|---|---|---|---|---|---|---|---|---|---|
| Ex | Base | wt % | MI | strength | ratio V | (LVE) | (peak) | SH | shear vis. | Time |
| No. | resin | A | (dg/min) | (cN) | (%) | (Pa · s) | (Pa · s) | Ratio | (Pa · s) | (s/100) |
| C-1 | B | 0 | 1.0 | 2.52 | 20.4 | — | — | | — | — |
| I-1 | | 1 | 1.0 | 3.63 | 18.9 | 48600 | 152325 | 3.1 | — | — |
| C2 | C | 0 | 2.0 | 1.24 | 23.6 | — | — | — | 4051 | 1.154 |
| I-2 | | 1 | 2.0 | 2.13 | 21.8 | 21570 | 49436 | 2.3 | 4011 | 1.262 |
| I-3 | | 3 | 1.9 | 3.41 | 18.5 | 21960 | 112325 | 5.1 | 4333 | 1.478 |
| C-3 | D | 0 | — | — | — | — | — | — | 2200 | 0.617 |
| I-4 | | 1 | 3.4 | 1.29 | 33.1 | 19767 | 32031 | 1.6 | 2254 | 0.677 |
| I-5 | | 3 | 3.3 | 2.24 | 31.0 | 20057 | 63766 | 3.2 | 2314 | 0 791 |
| I-6 | | 5 | 3.3 | 2.92 | 28.7 | 21582 | 72098 | 3.3 | 2449 | 0.954 |
| C-4 | E | 0 | 4.4 | 0.8 | 18.1 | — | — | — | 1082 | 0.320 |
| I-7 | | 1 | 4.4 | 1.7 | 53.8 | 12528 | 29469 | 2.4 | 1104 | 0.339 |
| I-8 | | 3 | 4.1 | 3.0 | 50.4 | 15992 | 52634 | 3.3 | 1179 | 0.410 |
| C-5 | F | 0 | 6.8 | 0.5 | 17.5 | — | — | — | 419.1 | 0.144 |
| I-9 | | 1 | 6.9 | 1.0 | 27.9 | 9898 | 14995 | 1.5 | 435.7 | 0.154 |
| I-10 | | 3 | 6.5 | 2.3 | 49.0 | 9502 | 17046 | 1.8 | 476.6 | 0.179 |

Comparative samples C-1 to C3 and Inventive samples I-1 to I-6 were tested for film applications. All blown films are made on a Hosokawa Alpine blown film line. Some of the general process parameters are in Table 2. The line was set with a 160 mm mono layer die which was connected to a 90 mm and 30 L/D single screw extruder. The films were made with a 60 mil die gap, 2.5 blow-up ratio. The targeted film gauge was 1.0 mil (25.4 microns). Extruder profile follows 330,330/350/350/350/350/350° F. setting. Die zones was set at 380/380/380/380° F.

TABLE 2

| | | | | 1% Secant | 1% Secant | | | | | | Puncture |
|---|---|---|---|---|---|---|---|---|---|---|---|
| | | Melt | Melt | Modulus, | Modulus, | MD | TD | | | Puncture | Break |
| EX | Output | Temp | Pressure | MD | TD | Tear | Tear | Haze | Dart | Force | Energy |
| No. | (lbs/hr) | (° F.) | (psi) | (psi) | (psi) | (g/mil) | (g/mi) | (%) | (g/mil) | (lbs/mil) | (in-lbs/mil) |
| C-1 | 198 | 431 | 5932 | — | — | — | — | — | — | — | — |
| | 271 | 445 | 7161 | 17078 | 17274 | 195 | 297 | 39.6 | >1400 | 16.3 | 59.4 |
| I-1 | 200 | 429 | 6205 | 18703 | 20769 | 204 | 349 | 1.9 | 1042 | 16.2 | 57.6 |
| | 311 | 464 | 7338 | 18980 | 20746 | 221 | 367 | 2.7 | 642 | 15.7 | 58.7 |
| C-2 | 200 | 403 | 4440 | 24314 | 25079 | 340 | 425 | 9.7 | 619 | 12.2 | 39.7 |
| | 290 | 414 | 5647 | 25460 | 25930 | 308 | 467 | 24.2 | 503 | 12.9 | 45.5 |
| I-2 | 200 | 400 | 4483 | 25177 | 28536 | 321 | 466 | 2.6 | 325 | 12.6 | 41.8 |
| | 290 | 411 | 5715 | 26678 | 30840 | 314 | 486 | 3.2 | 297 | 13.1 | 45.6 |
| I-3 | 199 | 403 | 4434 | 24432 | 29864 | 286 | 476 | 3.3 | 252 | 12.8 | 43.9 |
| | 290 | 415 | 5598 | 26077 | 30102 | 277 | 551 | 3.1 | 217 | 11.3 | 35.6 |
| I-4 | 200 | 391 | 3387 | 24932 | 28436 | 353 | 468 | 4.0 | 204 | 12.0 | 39.4 |
| | 291 | 395 | 4377 | 25907 | 30442 | 338 | 475 | 6.1 | 174 | 10.7 | 34.2 |
| I-5 | 200 | 389 | 3472 | 23635 | 28245 | 288 | 470 | 3.7 | 196 | 11.9 | 42.3 |
| | 291 | 395 | 4409 | 24719 | 30251 | 289 | 489 | 4.4 | 161 | 9.8 | 28.4 |
| I-6 | 199 | 389 | 3436 | 23261 | 27318 | 306 | 463 | 4.1 | 165 | 10.8 | 34.7 |
| | 291 | 392 | 4484 | 24565 | 30031 | 254 | 493 | 5.4 | 162 | 10.9 | 37.5 |

By blending 1-3 wt % of modifier A, the inventive samples show a substantial increase in melt strength, a strain hardening ratio over 1.5, and increase in relaxation time versus their respective comparative examples.

In comparative samples C-6 to C-7, and inventive samples I-11 to I-14 (See Table 3, below), the base resins G and H were prepared using bis(n-propyl cyclopentadienyl) hafnium dichloride/MAO catalysts systems in a gas phase reactor. Resins G has a density of 0.916 g/cm³, MI of 0.7 g/10 min, and I₂₁/I₂ ratio of 28. Resin H has a density of 0.918 g/cm3, MI of 1.0 g/10 min and I₂₁/I₂ ratio of 30. In particular, preparation of the G and H used in the following examples was substantially as described in the examples set forth in U.S. Pat. No. 6,956,088 B2, which is fully incorporated herein by reference. Process conditions were manipulated as needed to achieve resins having the resulting density and melt index. To prepare inventive samples I-11 to I-14, pellets of base resins and “A” was premixed in solid state and extruded on a 57 mm Werner & Pfleiderer twin screw extruder, i.e., ZSK-57. An antioxidant package was added into all the compounded compositions. The antioxidant consists of 0.05 wt % of Irganox™ 1076 and 0.1 wt % of Irganox™ 168 (available from BASF). The extruder temperature setting was at 180/185/190/195° C. The concentration is the weight percent of the final blend.

TABLE 3

| | | | | Melt | Draw | η_{E} | η_{E} | | Zero | Relaxation |
|---|---|---|---|---|---|---|---|---|---|---|
| Ex | Base | wt % | MI | strength | ratio V | (LVE) | (peak) | SH | shear vis. | Time |
| No. | resin | A | (dg/min) | (cN) | (%) | (Pa · s) | (Pa · s) | Ratio | (Pa · s) | (s/100) |
| C-6 | G | 0 | 0.68 | 3.64 | 15.6 | | | | | |
| I-11 | | 1 | 0.68 | 4.5 | 14.5 | 74400 | 129281 | 1.7 | | |
| I-12 | | 3 | 0.65 | 6.75 | 16.3 | 76500 | 182371 | 2.4 | | |
| C-7 | H | 0 | 1.38 | 2.68 | 29.6 | | | | 6289 | 4.62 |
| I-13 | | 1 | 1.39 | 3.89 | 34.6 | 56430 | 77340 | 1.4 | 6420 | 4.98 |
| I-14 | | 2 | 1.37 | 5.1 | 28.0 | 58945 | 104219 | 1.8 | 6483 | 5.26 |

Comparative samples C-6 and C-7, and Inventive samples I-11 to I-14 were tested for film applications (see Table 4, below). All blown films are made on a Hosokawa Alpine blown film line. Some of the general process parameters are in Table 4. The line was set with a 160 mm mono layer die which was connected to a 90 mm and 30 L/D single screw extruder. The films were made with a 60 mil die gap, 2.5 blow-up ratio. The targeted film gauge was 1.0 mil (25.4 microns). Extruder profile follows 330/330/350/350/350/350/350° F. setting. Die zones were set at 380/380/380/380° F.

TABLE 4

| | | | | 1% | 1% | | | | | | |
|---|---|---|---|---|---|---|---|---|---|---|---|
| | | | | Secant | Secant | | | | | Puncture | Puncture |
| | | Melt | Melt | Modulus, | Modulus, | MD | TD | | | Peak | Break |
| EX | Output | Temp | Pressure | MD | TD | Tear | Tear | Haze | Dart | Force | Energy |
| No. | (lbs/hr) | (° F.) | (psi) | (psi) | (psi) | (g/mil) | (g/mil) | (%) | (g/mil) | (lbs/mil) | (in-lbs/mil) |
| C-6 | 198 | 429.9 | 5,945 | 25469 | 31142 | 221 | 376 | 10 | 878 | 11.1 | 33.4 |
| | 345 | 483.6 | 7,097 | 26228 | 33112 | 211 | 393 | 11 | 896 | 12.1 | 38.8 |
| I-11 | 198 | 433.2 | 6,049 | 26370 | 31479 | 191 | 399 | 9 | 1004 | 11.4 | 34.6 |
| | 337 | 489.2 | 7,130 | 27349 | 35039 | 190 | 420 | 7 | 1082 | 11.3 | 35.3 |
| I-12 | 201 | 433.1 | 6,046 | 26120 | 31808 | 171 | 390 | 8 | 764 | 10.6 | 30.7 |
| | 333 | 489.2 | 7,072 | 26620 | 34272 | 178 | 426 | 8 | 810 | 12.1 | 38.2 |
| C-7 | 376 | 423 | 5,958 | 28441 | 33903 | 275 | 483 | >30 | 573 | 9.1 | 24.6 |
| I-13 | 436 | 435 | 6,300 | 33617 | 41330 | 189 | 505 | 11 | 351 | 9.7 | 26.8 |
| I-14 | 486 | 441 | 6,575 | 32939 | 41919 | 203 | 572 | 12 | 402 | 9.1 | 22.6 |

In comparative samples C-8 and C-9, and inventive samples I-15 and I-16 (see Table 5, below), the base resins B-F are ExxonMobil™ LLDPE LL1001.32 and LL1002KW, commercially available from ExxonMobil Chemical Company (Houston, Texas). To prepare inventive samples I-15 and I-16, pellets of base resins and “A” was premixed in solid state and extruded on a 57 mm Werner & Pfleiderer twin screw extruder, i.e. ZSK-57. An antioxidant package was added into all the compounded compositions. The antioxidant consists of 0.05 wt % of Irganox™ 1076 and 0.1 wt % of Irganox™ 168 (available from BASF). The extruder temperature setting was at 180/185/190/195° C. The concentration is the weight percent of the final blend.

TABLE 5

| | | | | Melt | Draw | η_{E} | η_{E} | | Zero shear | Relaxation |
|---|---|---|---|---|---|---|---|---|---|---|
| Ex | Base | wt % | MI | strength | ratio V | (LVE) | (peak) | SH | viscosity | Time |
| No. | resin | A | (dg/min) | (cN) | (%) | (Pa · s) | (Pa · s) | Ratio | (Pa · s) | (s/100) |
| C-8 | I | 0 | 1.15 | 3.57 | 24.1 | | | | 8823 | 10.25 |
| I-15 | | 1 | 1.11 | 5.15 | 28.9 | 70558 | 91851 | 1.3 | 9141 | 10.80 |
| C-9 | J | 0 | 2.07 | 2.1 | 25.8 | | | | 4688 | 4.85 |
| I-16 | | 1 | 2.08 | 2.53 | 37.6 | 39325 | 56261 | 1.4 | 4742 | 5.18 |

Comparative samples C-8 and C-9 and Inventive samples I-15 and I-16 were tested for film applications (see Table 6, below). All blown films are made on a Hosokawa Alpine blown film line. Some of the general process parameters are in Table 6. The line was set with a 160 mm mono layer die which was connected to a 90 mm and 30 L/D single screw extruder. The films were made with a 60 mil die gap, 2.5 blow-up ratio. The targeted film gauge was 1.0 mil (25.4 microns). Extruder profile follows 330/330/350/350/350/350/350° F. setting. Die zones was set at 380/380/380/380° F.

TABLE 6

| | | | | 1% Secant | 1% Secant | | | | | Puncture | Puncture |
|---|---|---|---|---|---|---|---|---|---|---|---|
| | | Melt | Melt | Modulus, | Modulus, | MD | TD | | | Peak | Break |
| EX | Output | Temp | Pressure | MD | TD | Tear | Tear | Haze | Dart | Force | Energy |
| No. | (lbs/hr) | (° F.) | (psi) | (psi) | (psi) | (g/mil) | (g/mil) | (%) | (g/mil) | (lbs/mil) | (in-lbs/mil) |
| C-8 | 415 | 429 | 7,018 | 28310 | 34617 | 67 | 529 | 17 | 78 | 8.6 | 23.0 |
| I-15 | 426 | 429 | 6,996 | 29675 | 36428 | 56 | 529 | 9 | 70 | 8.3 | 21.3 |
| C-9 | 356 | 394 | 5,158 | 27202 | 32822 | 75 | 454 | 19 | 69 | 7.4 | 19.1 |
| I-16 | 377 | 410 | 5,006 | 26268 | 35649 | 51 | 493 | 9 | <61 | 7.6 | 20.2 |

Overall, modified polyethylenes and films of the present disclosure can have, for example, high melt strength and maintained or improved melt viscosity and other film physical properties. Dart and MD tear properties are notably decreased to some extent, but only around a 10% and 20% reduction, respectively, while haze and processability are both substantially improved (haze reducing quite substantially by ˜50%). These attributes provide bubble stability improvement as compared to conventional compositions and methods and provide a substantial increase in output of film while maintaining the same or similar pressure. Increased melt strength (e.g., extensional strain hardening) allows a bubble to balance its own weight before solidifying, thus contributing to improved bubble stability, film gauge uniformity, and an ability to blow large bubbles (e.g., geomembranes). Therefore, the present blends are well-suited for a targeted application in films having superior balance of properties, particularly in applications where minimal haze is of key importance, all while being substantially easier to process and therefore substantially more economical for film producers.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its endpoints even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A modified polyethylene comprising the product of the combination of:
a) 95-99.9 wt % of a metallocene-catalyzed polyethylene comprising 85-99.9 wt % of units derived from ethylene and units derived from a C₃ to C₁₀ alpha-olefins, the polyethylene having a density of 0.900 to 0.940 g/cm³; and
b) from 0.10-5 wt % of a modifier comprising an elastomer having long-chain branching and further having at least 60 wt % of units derived from ethylene, 0-10 wt % of units derived from a cyclic-diene monomer; and the balance of unites derived from one or more C₃ to C₁₀ α-olefins, wherein the elastomer has a Mooney viscosity of 10 to 40 MU (ML, 1+4 @100° C.).

2. The modified polyethylene of claim 1, wherein the metallocene-catalyzed polyethylene is selected from one or more of the following: (i) a narrow-CD mLLDPE having CDBI of at least 60% and molecular weight distribution (MWD, defined as Mw/Mn) within the range from 1.5 to 4; (ii) a long-chain-branched mLLDPE having CDBI of greater than or equal to 70% and melt index ratio (MIR) within the range from 20 to 40; (iii) narrow MWD BOCD-mLLDPE having MWD within the range from 2.0 to 4.5, CDBI of less than 40%, and a broad orthogonal composition distribution; and (iv) a broad-BOCD-mLLDPE having MWD within the range from 6 to 10, a CDBI of less than 40%, and a broad orthogonal composition distribution.

3. The modified polyethylene of claim 2, wherein the polyethylene is the narrow-CD mLLDPE, and further has one or more of the following properties:
a) CDBI within the range from 60% to 80%;
b) a melt index (I_{2.16}) within the range from 0.1 to 5 g/10 min,
c) weight average molecular weight (Mw) within the range from 45,000 to 120,000 g/mol;
d) number average molecular weight (Mn) within the range from 20,000 to 55,000 g/mol; and
e) density within the range from 0.905 to 0.940 g/cm³.

4. The modified polyethylene of claim 2, wherein the polyethylene is the long-chain-branched mLLDPE, and further has one or more of the following properties:
a) MIR within the range from 25 to 35;
b) Shear thinning ratio (STR) less than 15;
c) An inflection point in a Van Gurp Palmen plot of phase angle vs. complex modulus (Pa) of the polyethylene; and
d) High load melt index (HLMI) within the range from 10 to 75 g/10 min.

5. The modified polyethylene of claim 2, wherein the polyethylene is the narrow MWD BOCD-mLLDPE, and further has one or more of the following properties:
a) Mw within the range from 20,000 to 200,000 g/mol;
b) Mz/Mw greater than 1.5;
c) T₇₅−T₂₅ within the range from 5 to 10;
d) CDBI less than 35%;
e) a melt index (I_{2.16}) of 0.1-5 g/10 min, and
f) a MIR of 20-35.

6. The modified polyethylene of claim 2, wherein the polyethylene is the broad BOCD-mLLDPE, and further has one or more of the following properties:
a) MWD within the range from 6.4 to 9.5;
b) T₇₅−T₂₅ of 15° C. or greater; and
c) CDBI less than 35%.

7. The modified polyethylene of claim 1, wherein the C₃ to C₁₀ alpha-olefin units of the metallocene catalyzed polyethylene are selected from the group consisting of 1-butene, 1-hexene, and 1-octene.

8. The modified polyethylene of claim 1, wherein the modifier has one or more of the following properties:
a) A Mooney Relaxation Area (MLRA) within the range from 100 to 500 MU-sec;
b) phase angle (δ) at complex modulus G*=1.1×10⁵ Pa within the range from 20° to 45°;
c) tan(δ) at 0.245 Rad/s within the range from 0.500 to 0.800; and
d) shear thinning ratio (STR) within the range from 50 to 300.

9. The modified polyethylene of claim 8, wherein the modifier has one or more of the following properties:
a) phase angle (δ) at complex modulus G*=1.1×10⁵ Pa within the range from 28° to 45°;
b) tan(δ) at 0.245 Rad/s within the range from 0.550 to 0.800; and
c) STR within the range from 75 to 250.

10. The modified polyethylene of claim 8, wherein the cyclic-diene monomer is selected from the group consisting of dicyclopentadiene (DCPD), norbornadiene (NBD), 5-vinyl-2-norbornene (VNB), ethylidene norbornene (ENB), derivatives thereof, and combinations thereof.

11. The modified polyethylene of claim 10, wherein the cyclic-diene monomer is 5-vinyl-2-norbornene (VNB).

12. The modified polyethylene of claim 1, wherein the modified polyethylene comprises from 0.50-5.0 wt % of the modifier.

13. A film comprising the modified polyethylene of claim 1.

14. The film of claim 13 wherein the film is produced by a blown film extrusion process has a measured haze at least 50% lower than a film produced by the same blown film extrusion process using the polyethylene component of the modified polyethylene in place of the modified polyethylene.

15. The film of claim 13 wherein the film is produced by a blown film extrusion process and has one or more of the following properties:
(a) a strain hardening ratio at least 1% higher than a film produced by the same blown film extrusion process using the polyethylene component of the modified polyethylene in place of the modified polyethylene;
(b) a puncture force at least 90% of the value measured for a film produced by the same blown film extrusion process using the polyethylene component of the modified polyethylene in place of the modified polyethylene;
(c) a puncture break energy at least 90% of the value measured for a film produced by the same blown film extrusion process using the polyethylene component of the modified polyethylene in place of the modified polyethylene;
(d) a TD 1% secant modulus at least 1% higher than a film produced by the same blown film extrusion process using the polyethylene component of the modified polyethylene in place of the modified polyethylene;
(e) a MD 1% secant modulus at least 1% higher than a film produced by the same blown film extrusion process using the polyethylene component of the modified polyethylene in place of the modified polyethylene;
(f) a MD tear at least 1% higher than a film produced by the same blown film extrusion process using the polyethylene component of the modified polyethylene in place of the modified polyethylene; and
(g) a Dart Drop impact of at least 90% of the value measured for a film produced by the same blown film extrusion process using the polyethylene component of the modified polyethylene in place of the modified polyethylene.

16. The film of claim 15, having all of the properties (a)-(g).
